(19) United States
(12) Patent Application Publication
(10) Pub. No.: US 2018/0135921 A1
(43) Pub. Date: May 17, 2018

(54) FIN OF A HEAT EXCHANGER, NOTABLY FOR A MOTOR VEHICLE, AND CORRESPONDING HEAT EXCHANGER

(71) Applicant: Valeo Systemes Thermiques, Le Mesnil Saint Denis (FR)

(72) Inventors: Erwan Etienne, Le Mesnil Saint Denis (FR); Patrick Boisselle, Le Mesnil Saint Denis (FR); Samuel Bry, Le Mesnil Saint Denis (FR); Jean-Philippe Berthome, Le Mesnil Saint Denis (FR)

(73) Assignee: Valeo Systemes Thermiques, Le Mesnil Saint Denis (FR)

(21) Appl. No.: 15/580,116

(22) PCT Filed: Jun. 10, 2016
(86) PCT No.: PCT/EP2016/063392

§ 371 Date: Dec. 6, 2017

(30) Foreign Application Priority Data
Jun. 12, 2015 (FR) 1555343

(51) Int. Cl. F28F 1/20; B23P 15/26

(52) U.S. Cl. CPC F28F 1/20; B23P 15/26

(57) ABSTRACT

The invention concerns a fin of a heat exchanger, notably for a motor vehicle, comprising at least one orifice (22) of substantially longitudinal shape, intended to have passing through it a tube of the heat exchanger, said at least one orifice (22) being bordered by a flange (32) formed as an integral part of the fin.

According to the invention, the flange (32) is produced with a shape substantially curved with respect to the general plane defined by the fin, such that it has a radius of curvature (R1, R2) between the general plane defined by the fin (20) and the top of the flange (32) and the top of the flange (32) projecting from the general plane defined by the fin (20), the radius of curvature of the flange being at a minimum (R1) at the ends of the associated orifice (22) and at a maximum (R2) in a substantially central region along the longitudinal axis of the associated orifice (22).

The invention concerns the field of heat exchangers for motor vehicles, and more specifically concerns a fin for such a heat exchanger.

Heat exchangers for motor vehicles comprising, in particular, a bundle of tubes arranged parallel to each other in one or more rows, said tubes being intended to allow a heat-transfer fluid to flow through the heat exchanger, are already known. The tubes in question are, in particular, tubes known as “flat tubes” designed to be arranged in a heat exchanger that has a small space requirement.

The function of such a heat exchanger is to allow heat exchange between the heat-transfer fluid flowing inside the row or rows of aligned tubes and an external fluid, such as a flow of air, passing through the row or rows of tubes, for example in a direction transverse to the longitudinal axis of the tubes.

In order to increase the heat exchanges between the fluids, heat exchangers are commonly provided with a plurality of heat-exchange elements arranged between the tubes. The heat-exchange elements are advantageously parallel fins, each being perforated by at least one orifice, advantageously by a plurality of orifices intended to receive the tubes of the heat exchanger. These orifices are arranged in one or more rows, depending on whether the bundle of tubes comprises one or more rows of tubes, for example parallel to a longitudinal direction, corresponding to the large dimension of the fin.

The tubes and the orifices in the fins can be oblong in shape. A heat exchanger comprising a plurality of fins and tubes, the tubes having, respectively, before being shaped in the heat exchanger, an oblong cross section substantially corresponding to that of an orifice in a fin, is already known from document FR 2 722 563. In particular, a tube comprises two opposing longitudinal flanks, which are curved, each having at least one concave portion (i.e. a portion with a convexity turned towards the inside of the tube), giving the tube, in particular, a smaller external width in a region where its longitudinal flanks are closest together.

The entire perimeter of each orifice of a fin is also bordered by a flange.

The assembly formed by a fin and the tubes that pass through it is then held together mechanically by deforming the walls of the tubes, in particular by expanding the tubes, in such a way as to press-fit the tubes against the flanges around the orifices provided in the fins.

In order to further improve the heat exchanges, deflecting or disturbing the flow of external fluid passing between the fins is known. For this purpose, the fins can be provided, in particular, with louvred deflectors, arranged between two successive orifices in the same row.

However, when the tubes are shaped in the heat exchanger, the deformations of each tube are transmitted to the louvres. The louvres can therefore be deformed in turn, which degrades the performance of the heat exchanger. The shaping of the tubes in the heat exchanger is therefore limited by the risk of deforming the louvres.

Therefore, in the solutions of the prior art, each orifice is provided with a flange with a constant radius of curvature that is relatively small, i.e. of the order of 0 to 0.05 mm. This results in a very rigid flange.

However, the rigidity of the flange transmits the expansion forces from the tube to the louvres, which can cause the louvres to become deformed after expansion, in particular when the tubes have maximum dimensions within their tolerances. Moreover, if the radius of curvature of the flange is increased, there is a risk of the flange being deformed.

The aim of the invention is therefore to at least partially address these problems of the prior art by proposing a fin for a heat exchanger that has good mechanical strength while reducing the risk of the expansion forces being transmitted from the tube or tubes to the fin and to the elements of the fin, such as louvres.

To this end, the invention concerns a fin of a heat exchanger, notably for a motor vehicle, comprising at least one orifice of substantially longitudinal shape, intended to have passing through it a tube of the heat exchanger, said at least one orifice being bordered by a flange formed as an integral part of the fin, characterized in that:
the flange is produced with a shape substantially curved with respect to the general plane defined by the fin, such that it has a radius of curvature between the general plane defined by the fin and the top of the flange projecting from the general plane defined by the fin, and in that
the radius of curvature of the flange is at a minimum at the ends of the associated orifice and at a maximum in a substantially central region along the longitudinal axis of the associated orifice.

Each flange is produced, for example, by deforming the edge of an associated orifice of the fin.

The flange has a progressive radius of curvature, such that the radius of curvature of the flange changes along the perimeter of the orifice.

Therefore, the radius of curvature of the flange is small in certain locations, which provides a certain rigidity and contributes to the mechanical strength of the fin. Conversely, substantially in the middle of the largest length of the orifice, the radius of curvature of the flange is larger, making the flange more flexible and contributing less to the mechanical strength of the fin.

This design flexibility, in the middle of the orifice intended to receive, in particular, a wider portion of a tube of the heat exchanger, makes it possible, in particular when the tube is thicker than the nominal thickness, to reduce the risk deformations being transmitted from the tube, for example by expansion, to the fin, and in particular to louvres provided on the fin.

Said fin can moreover comprise one or more of the following features, taken separately or in combination.

According to one aspect of the invention, the minimum radius of curvature is less than or equal to 0.05 mm and the maximum radius of curvature is greater than or equal to 0.15 mm.

Preferably, the maximum radius of curvature of the flange is of the order of 0.22 mm.

Advantageously, the maximum radius of curvature of the flange is less than the height of the flange.

According to one embodiment, the height of the flange is of the order of 0.3 mm.

This configuration allows at least one area of the flange, i.e. the top of the flange, to conform to the shape of a tube passing through the orifice.

According to another aspect of the invention, the shape of each orifice is variable in width, and the flange bordering an associated orifice has a minimum radius of curvature in the region or regions of the orifice with a smaller width. This or each region with a smaller width forms a region useful to the mechanical strength of the fin and requires a more rigid flange at this location.

According to one embodiment, each orifice is substantially oblong in shape, comprising two opposing longitudinal edges, each longitudinal edge having at least two convex portions, as viewed from inside the orifice, and the flange bordering an associated orifice has a minimum radius of curvature at the convex portions of each longitudinal edge of the orifice.

The two longitudinal edges of an orifice can be connected by two substantially circular end portions, and the flange bordering an associated orifice has a minimum radius of curvature at the two end portions.

According to another aspect of the invention, each orifice is wider in the middle of the largest length of the orifice than in the remaining region of the orifice.

The flange bordering an associated orifice therefore has a maximum radius of curvature in the central region of the orifice with a larger width. This central region is intended, in particular, to receive a wider and more flexible portion of the tube, and contributes less to the mechanical strength of the fin-and-tube assembly. By using a flange that is less rigid at this location, the deformations of the tube at assembly are not transmitted to the fin and, for example, to louvres provided on the fin.

According to one embodiment, each longitudinal edge has a concave portion, as viewed from inside the orifice, separating the two convex portions, and the flange bordering an associated orifice has a maximum radius of curvature at the concave portion of each longitudinal edge of the orifice.

The invention also concerns a heat exchanger, notably for a motor vehicle, comprising at least one tube and at least one fin as previously defined, intended to have passing through it said at least one tube.

In particular, it concerns a mechanically assembled heat exchanger.

Thus, during mechanical assembly, the tube is inserted through an orifice of a fin, or indeed through several aligned orifices of a plurality of fins, and is then deformed, in particular by expansion, and comes to press against the flange of each orifice through which it passes. The rigidity of the flange in certain locations, in particular at the ends of the orifice, provide the mechanical strength of the tube-and-fin assembly, while this flange has a certain flexibility in the central region, this flexibility preventing the expansion forces from being transmitted from the tube to the fin, and in particular to louvres that can be provided on the fin.

Said heat exchanger can moreover comprise one or more of the following features, taken separately or in combination.

According to one aspect of the invention, said at least one fin has at least one orifice, the shape of which matches the shape of said at least one tube and the dimensions of which are larger than the dimensions of the cross section of the tube passing through it, in order to allow the tube to be inserted through the associated orifice of the fin.

Advantageously, the tube has, prior to shaping in the orifice, in particular by expansion, a shape substantially identical to the shape of the associated orifice of the fin. This similarity of the shapes prior to assembly help reduce, in particular, constriction forces during the expansion of the tube.

According to another aspect of the invention, the tube has a cross section of variable width, and the flange bordering an associated orifice of the fin has a minimum radius of curvature in an area of the orifice receiving a narrower portion of the tube and has a maximum radius of curvature in an area of the orifice receiving a wider portion of the tube.

Therefore, the radius of curvature changes gradually from the minimum radius of curvature where the tube is at its narrowest, in particular in the end regions of the tube, so as to ensure proper tightening, to the maximum radius of curvature where the tube is at its widest, for a more flexible assembly, such that deformations of the tube at assembly are not transmitted to the fin and to the elements it carries, such as louvres.

According to one embodiment:
each tube has a cross section comprising two opposing longitudinal flanks, each longitudinal flank having at least two concave portions, as viewed from outside the tube,
each orifice of a fin is substantially oblong in shape, each longitudinal edge of an orifice having at least two convex portions, as viewed from inside the orifice, matching the two concave portions of the tube passing through the associated orifice and
the flange bordering an associated orifice has a minimum radius of curvature at the convex portions of each longitudinal edge of the orifice.

In particular, in the end regions of a tube passing through an orifice of the fin and where the longitudinal flanks of the tube are closest to each other, the radius of curvature is at a minimum so as to provide the fin with good mechanical strength and in particular prevent the fins from sliding off the tubes during vibration tests, for example.

According to one particular embodiment,
each longitudinal flank of a tube has a convex portion, as viewed from outside the tube, separating two concave portions,
each longitudinal edge of an orifice has a concave portion, as viewed from inside the orifice, separating two convex portions, and matching the convex portion of the tube passing through the orifice, and
the flange bordering an associated orifice has a maximum radius of curvature at the concave portion of each longitudinal edge of the orifice.

In particular, in the region where the longitudinal flanks of a tube passing through an orifice of the fin are the furthest away from each other, the tube is more flexible and the radius of curvature of the flange is at a maximum, so as to give the flange a certain flexibility, reducing the risk of deformations being transmitted from the tube to the fin.

Other features and advantages of the invention will become clearer on reading the description that follows, provided as an illustrative and non-limiting example, and viewing the appended drawings in which:

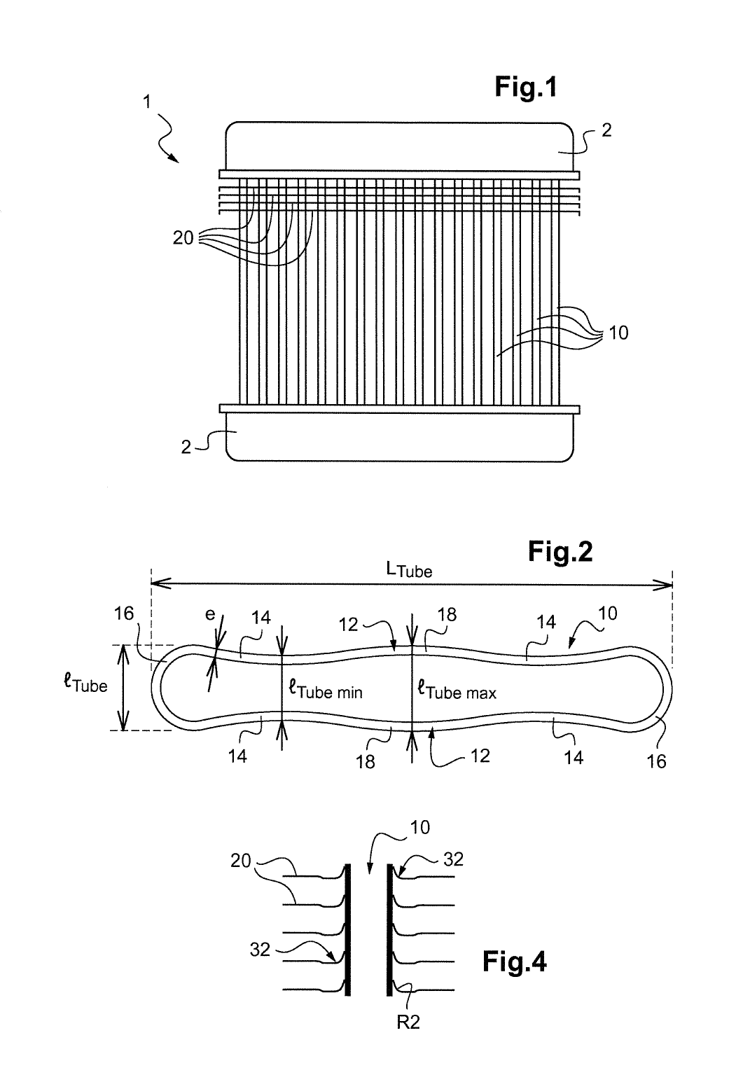

FIG. 1 is a general schematic view of a heat exchanger comprising fins and tubes passing through the fins,

FIG. 2 is a cross section view of a tube of the heat exchanger of FIG. 1 according to one embodiment,

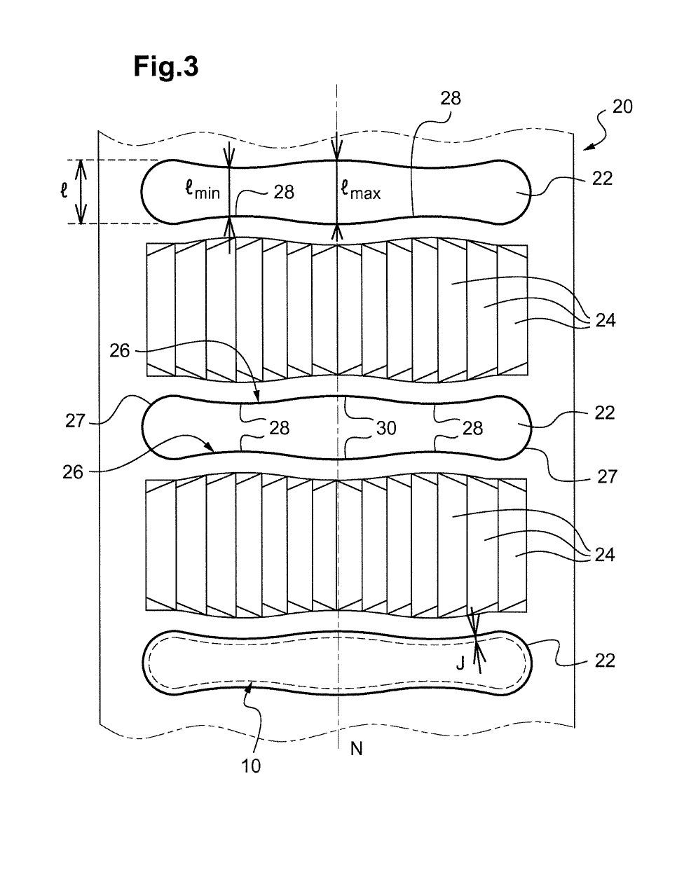

FIG. 3 is a view of a portion of a fin of the heat exchanger of FIG. 1 intended to receive a row of tubes of FIG. 2,

FIG. 4 is a partial cross section view substantially in the middle of a tube passing through a plurality of parallel fins of the heat exchanger of FIG. 1,

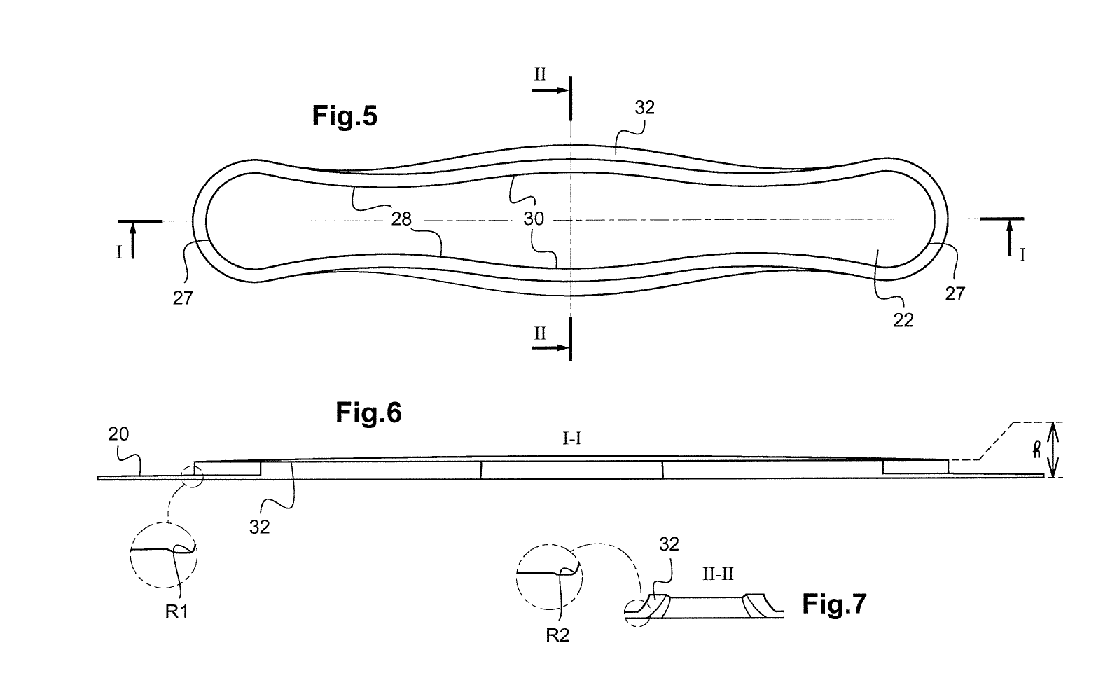

FIG. 5 is a view of a flange surrounding an orifice of the fin of FIG. 3,

FIG. 6 is a cross section view along the axis I-I of FIG. 5, and

FIG. 7 is a cross section view along the axis II-II of FIG. 5.

In these figures, the elements that are identical have been given the same reference numbers.

The following embodiments are examples. Although the description refers to one or more embodiments, this does not necessarily mean that each reference concerns the same embodiment, or that the features apply only to a single embodiment. Single features of different embodiments may also be combined to provide other embodiments.

The invention concerns the field of a heat exchanger 1, notably for a motor vehicle, as shown schematically in FIG. 1.

In particular, it concerns a heat exchanger 1 referred to as a mechanically assembled heat exchanger, i.e. the components of which are connected together only by mechanical assembly, for example by shape engagement followed by deformation, unlike a brazed exchanger that requires thermal action on the heat exchanger 1.

The heat exchanger of FIG. 1 comprises, as is usually the case, two collection boxes 2 brought into communication by means of a series of tubes 10 in which a heat-transfer fluid flows. The tubes 10 are arranged substantially parallel to each other. The tubes 10 are, in the case described here, flat tubes, but could also be tubes with a cross section that is circular, oval or in any other shape known to a person skilled in the art. The heat exchanger 1 further comprises fins 20 arranged parallel to each other, between the collection boxes 2, substantially transverse to the longitudinal axis of the tubes 10. Heat exchange takes place between the heat-transfer fluid flowing inside the tubes 10, and an external fluid, such as a flow of air, by conduction between the fins 20 and the tubes 10, and by convection of the flow of air flowing between the fins 20.

In reference to FIG. 2, an embodiment of a tube 10 is shown prior to its shaping by deformation.

The tube 10 is advantageously produced from a metal alloy capable of being easily deformed.

According to the embodiment shown, the tube 10 has a substantially oblong cross section comprising two opposing longitudinal flanks 12. The two longitudinal flanks 12 are connected to each other by two substantially circular end portions 16. The two longitudinal flanks 12 and the two end portions 16 are formed by a wall of the tube 10 that has a substantially constant thickness e.

According to the cross section, the tube 10 has a length L_{Tube} designating the largest distance separating the two substantially circular end portions 16, on the outside of the tube 10, and a width l_{Tube} designating the smallest distance between the two longitudinal flanks 12 of the tube, on the outside of the tube 10.

Moreover, in this example, the tube 10 has a cross section of which the width l_{Tube} varies between a minimum width l_{Tube min} and a maximum width l_{Tube max}.

More specifically, according to this example, each longitudinal flank 12 has at least two concave portions 14, as viewed from outside the tube 10. A concave portion 14 of a longitudinal flank 12 of the tube 10 should be taken to mean a portion with a convexity turned towards the inside of the tube 10. In other words, as viewed from outside the tube 10, the tube 10 comprises two substantially curved recessed shapes 14.

Moreover, a convex portion 18 can be arranged between the two concave portions 14 of each longitudinal flank 12, as viewed from outside the tube 10. A convex portion 18 of a longitudinal flank 12 of the tube 10 should be taken to mean a portion with a convexity turned towards the outside of the tube 10. Therefore, as viewed from outside the tube 10, each longitudinal flank 12 of the tube 10 has a projecting portion 18 arranged between the two recessed shapes 14.

The concave portions 14 are in this case provided at the two ends of each longitudinal flank 12 of the tube 10, while the convex portion 18 separating them is in this case arranged substantially in the middle of the longitudinal flank 12.

Therefore, according to this example, the tube 10 is narrower in the areas where the two opposing longitudinal flanks 12 are closest together, i.e. at two facing concave portions 14. The tube 10 is wider in the area where the two opposing longitudinal flanks 12 are furthest apart from each other, i.e. in this example, at two facing convex portions 18. In other words, the external width l_{Tube} of the tube 10 is smaller at the facing concave portions 14 than at the facing convex portions 18.

This gives the tube 10, in this case, a particular shape that helps prevent the elastic return of the longitudinal flanks 12 of the tube 10 after it has been shaped.

FIG. 3 shows a portion of one of the fins 20 of FIG. 1. The fin 20 is in the form of a thin sheet metal strip also referred to as a strip, for example made from aluminum alloy, perforated with a plurality of orifices 22. The orifices 22 of a fin 20 can be separated, two by two, by deflectors, in this case in the faun of rows of louvres 24, the function of which is to increase the heat exchange of the fins 20 by deflecting and/or disturbing the flow of an external fluid passing through the heat exchanger 1.

The shape of the fin 20 in this example is substantially rectangular.

The louvres 24 in this example are arranged aligned in the width direction of the fin 20 between two orifices 22 of a given row. The louvres 24 are produced, for example, in such a way as to project obliquely from the surface of the fin 20.

The orifices 22 are arranged in a row of axis N. The axis N is, for example, substantially parallel to the longitudinal direction of the fin 20.

The orifices 22 allow the tubes 10 to pass through the fin 20. The shape of the orifices 22 is therefore adapted to the cross section of the tubes 10.

In the case of flat tubes 10, the orifices 22 are advantageously longitudinal in shape.

More specifically, in the case of tubes 10 with a cross section of variable width l_{Tube,} each orifice 22 has a substantially longitudinal shape, the width l of which varies between a minimum width lₘᵢₙ and a maximum width lₘₐₓ.

According to the embodiment shown, each orifice 22 has two regions, in this case end regions, with a smaller width lₘᵢₙ and a substantially central region along the longitudinal axis of the orifice 22 that has a larger width lₘₐₓ.

More specifically, each orifice 22 (see FIG. 3) has a substantially oblong cross section comprising two opposing longitudinal edges 26, matching the shape of a tube 10 as described in reference to the example of FIG. 2. The two longitudinal edges 26 are connected by two substantially circular end portions 27. Moreover, according to the embodiment shown, each longitudinal edge 26 of an orifice 22 has at least two convex portions 28, as viewed from inside the orifice 22. A convex portion 28 of a longitudinal edge 26 of an orifice 22 of the fin 20, should be taken to mean a portion with a convexity turned towards the inside of the orifice 22. The convex portions 28 of a longitudinal edge 26 of an orifice 22 match the concave portions 14 of an associated tube 10 intended to pass through this orifice 22.

In this example, the two convex portions 28 of a longitudinal edge 26 of the orifice 22 are separated by a concave portion 30, as viewed from inside the orifice 22 of the fin 20. A concave portion 30 of a longitudinal edge 26 of an orifice 22 of the fin 20, should be taken to mean a portion with a convexity turned towards the outside of the orifice 22. Therefore, as viewed from inside the orifice 22, each longitudinal edge 26 has one recess 30 and two projecting portions 28. Each concave portion 30 of an orifice 22 matches a convex portion 18 of an associated tube 10 intended to pass through this orifice 22.

The convex portions 28 are in this case provided at the two ends of each longitudinal edge 26 of the orifice 22, while the concave portion 30 separating them is in this case arranged substantially in the middle of the longitudinal edge 26.

Therefore, according to this example, the orifice 22 is narrower in the areas where the two opposing longitudinal edges 26 are closest together, i.e. at two facing convex portions 28. The orifice 22 is wider in the area where the two opposing longitudinal edges 26 are furthest apart from each other, i.e. in this example, at two facing concave portions 30.

Naturally, any other shape of the orifice 22 can be provided, as long as this shape is suitable for an associated tube 10 of the heat exchanger 1 to pass through it.

Each orifice 22 of a fin 20 therefore has a shape substantially identical to that of a tube 10 before the tube 10 is shaped, and the shape of each orifice 22 is larger than the cross-sectional shape of a matching tube 10, so as to allow the tube 10 to be inserted through the orifice 22. A tube 10 received in an orifice 22 of the fin 20 is shown schematically by the dashes in FIG. 3.

More specifically, each orifice 22 is configured to accommodate a tube 10 as described above, such that an assembly formed by an orifice 22 provided with a tube 10 has a clearance J between the tube 10 and the corresponding orifice 22 that receives it. The clearance J is advantageously present between the tube 10 and the orifice 22, around the entire periphery of the tube 10. Thus, during assembly, the tube 10 is positioned in an orifice 22 of at least one fin 20 in such a way that the tube 10 is placed forming a clearance J between the tube 10 and the orifice 22. The tube 10 can subsequently be deformed, for example by expanding its walls inside the orifice 22 of the fin 20.

Moreover, each tube 10 can be intended to be inserted through aligned orifices 22 of a plurality of fins 10 arranged parallel to each other, as shown schematically in FIG. 4.

Each orifice 22 is, moreover, bordered by a flange 32, shown schematically in FIG. 5. The flange 32 is advantageously provided around the entire perimeter of the orifice 22 and formed as an integral part of the fin 20.

Each flange 32 can be produced by deforming the edge of the associated orifice 22. The flanges 32 are, for example, formed by drawing. This results in the flange 32 having a portion that is raised relative to the general plane of the fin 20, which therefore projects from the general plane of the fin 20, this projecting portion being referred to hereinafter as the top of the flange 32. This projecting portion can extend substantially perpendicular to the general plane defined by the fin 20.

The general shape of each flange 32 substantially matches the shape of the associated orifice 22.

Moreover, each flange 32 is produced with a shape substantially curved with respect to the general plane defined by the fin 20. In other words, each flange 32 has a radius of curvature R1, R2 between the general plane defined by the fin 20 and the top of the flange 32. In particular, the radius of curvature of the flange 32 is at a minimum R1, or indeed zero, at the ends of the associated orifice 22 and at a maximum R2 in a substantially central region of the associated orifice 22, in the longitudinal direction.

The flange 32 therefore has a progressive radius of curvature. In other words, the radius of curvature of the flange 32 is not the same along the perimeter of the orifice 22.

More specifically, the minimum radius of curvature R1 (FIG. 6) is, for example, of the order of 0 to 0.05 mm, and the maximum radius of curvature R2 (FIG. 7) is, for example, greater than or equal to 0.15 mm.

According to one particular embodiment, the maximum radius of curvature R2 is preferably of the order of 0.22 mm.

Thus, once a tube 10 has been assembled in an associated orifice 22 and shaped, the wall of the tube 10 presses tightly against the flange 32 bordering the orifice 22, in order to keep the tube 10 assembled with the fin 20 and simultaneously provide a good thermal connection between them. More specifically, at least one area of the flange 32, in this case the top of the flange 32, in reference to FIG. 4, conforms to the shape of the tube 10, after assembling the latter in the associated orifice 22.

Advantageously, the maximum radius R2 of the flange 32 is less than the height h of the flange 32, in order to allow at least one area of the flange 32 to be substantially perpendicular to the tube 10 and to conform to the shape of the tube 10. According to the specific embodiment shown, the height h of the flange 32 is of the order of 0.3 mm.

In particular, in reference to FIGS. 5 and 6, a flange 32 bordering an associated orifice 22 has a minimum radius of curvature R1 in the region of the orifice 22 with a smaller width lₘᵢₙ, i.e. where the two longitudinal edges 26 are closest together. In other words, according to the specific embodiment of the orifice 22 of which each longitudinal edge 26 has at least two convex portions 28, each flange 32 bordering an associated orifice 22 has a minimum radius of curvature R1 at the convex portions 28 of each longitudinal edge 26 of the orifice 22.

Moreover, the flange 32 according to this example also has a minimum radius of curvature R1 at the two end portions 27 of the orifice 22 linking the two longitudinal edges 26.

Besides, in reference to FIGS. 5 and 7, the flange 32 has a maximum radius of curvature R2, larger than the minimum radius of curvature R1, in the region of the orifice 22 where the two longitudinal edges 26 are furthest apart from each other. In other words, according to the specific embodiment of the orifice 22 of which each longitudinal edge 26 has at least two convex portions 28 separated by a concave portion 30, each flange 32 bordering an associated orifice 22 has a maximum radius of curvature R2 at the concave portion 30 of each longitudinal edge 26 of the orifice 22.

Therefore, when the tube 10 is assembled in an associated orifice 22 of the fin 20, the radius of curvature of the flange 32 is smaller (minimum radius of curvature R1) in an area of the orifice receiving the ends of the tube 10 and a narrower portion of the tube 10, and the radius of curvature is larger (maximum radius of curvature R2), substantially in the central region of the orifice 22 in the longitudinal direction, this central region receiving a wider portion of the tube 10.

A fin 20 that has one or more orifices 22, each bordered by a flange 32 according to the invention, conforming to the shape of the tube 10 after assembly by expansion in an orifice 22, therefore has good mechanical strength provided by the rigidity of the flange 32 in the end regions with a small radius of curvature R1, without the expansion forces from the tube 10 being transmitted to the fin 20 or in particular to louvres 24 provided on the fin 20, owing to the flexibility of the flange 32 provided by a larger radius of curvature R2, in particular in a central region of the orifice.

1. A fin of a heat exchanger for a motor vehicle, comprising:
at least one orifice of substantially longitudinal shape, through which a tube of the heat exchanger passes, said at least one orifice being bordered by a flange formed as an integral part of the fin,
wherein:
the flange is produced with a shape substantially curved with respect to the general plane defined by the fin, such that the flange has a radius of curvature between the general plane defined by the fin and the top of the flange projecting from the general plane defined by the fin, and
the radius of curvature of the flange is at a minimum at the ends of the associated orifice and at a maximum in a substantially central region along the longitudinal axis of the associated orifice.

2. The fin as claimed in claim 1, in which the minimum radius of curvature is less than or equal to 0.05 mm and the maximum radius of curvature is greater than or equal to 0.15 mm.

3. The fin as claimed in claim 2, in which the maximum radius of curvature of the flange is less than the height of the flange.

4. The fin as claimed in claim 1, wherein the shape of each orifice is variable in width, and the flange bordering an associated orifice has a minimum radius of curvature in at least one region of the orifice with a smaller width.

5. The fin as claimed in claim 4, wherein:
each orifice is substantially oblong in shape, comprising two opposing longitudinal edges, each longitudinal edge having at least two convex portions, as viewed from inside the orifice, and
the flange bordering an associated orifice has a minimum radius of curvature at the convex portions of each longitudinal edge of the orifice.

6. The fin as claimed in claim 5, wherein each orifice is wider substantially in the middle of the largest length of the orifice than in a remaining region of the orifice.

7. The fin as claimed in claim 6, wherein:
each longitudinal edge has a concave portion, as viewed from inside the orifice, separating the two convex portions, and
the flange bordering an associated orifice has a maximum radius of curvature at the concave portion of each longitudinal edge of the orifice.

8. A mechanically assembled heat exchanger for a motor vehicle, comprising:
at least one tube; and
at least one fin as claimed in claim 1, wherein said at least one tube passes through the at least one fin.

9. The heat exchanger as claimed in claim 8, wherein said at least one fin has at least one orifice, the shape of which matches the shape of said at least one tube and the dimensions of which are larger than the dimensions of the cross section of the tube passing through the at least one orifice.

10. The heat exchanger as claimed in claim 8, wherein:
said at least one tube has a cross section of which the width varies, and
the flange bordering an associated orifice of the fin through which a tube passes, has a minimum radius of curvature in an area of the orifice receiving a narrower portion of the tube and has a maximum radius of curvature in an area of the orifice receiving a wider portion of the tube.

11. The heat exchanger as claimed in claim 10, wherein:
each tube has a cross section comprising two opposing longitudinal flanks, each longitudinal flank having at least two concave portions, as viewed from outside the tube,
each orifice of a fin is substantially oblong in shape, comprising two opposing longitudinal edges, each longitudinal edge of an orifice having at least two convex portions, as viewed from inside the orifice, matching the two concave portions of the tube passing through the associated orifice, and
the flange bordering an associated orifice has a minimum radius of curvature at the convex portions of each longitudinal edge of the orifice.

12. The heat exchanger as claimed in claim 11, wherein:
each longitudinal flank of a tube has a convex portion, as viewed from outside the tube, separating two concave portions,
each longitudinal edge of an orifice has a concave portion, as viewed from inside the orifice, separating two convex portions, and matching the convex portion of the tube passing through the orifice, and
the flange bordering an associated orifice has a maximum radius of curvature at the concave portion of each longitudinal edge of the orifice.
